(19) United States
(12) Patent Application Publication
(10) Pub. No.: US 2012/0134608 A1
(43) Pub. Date: May 31, 2012

(54) ROLLING ELEMENT RETAINER CHAIN

(76) Inventors: MING-CHE HSU, Tainan (TW); Lih-Fen CHEN, Tainan (TW)

(21) Appl. No.: 13/360,810

(22) Filed: Jan. 30, 2012

Related U.S. Application Data
(63) Continuation-in-part of application No. 12/243,966, filed on Oct. 1, 2008, now abandoned.

(51) Int. Cl. F16C 29/06

(52) U.S. Cl. 384/44; 384/43

(57) ABSTRACT

A rolling element retainer chain provides a row of rolling elements smooth running in a recirculation passage and keeps a predetermined spacing distance between two adjacent rolling elements and the rolling elements be separated without contact to each other; the rolling element retainer chain comprises at least one thin flexible metal strip having a row of longitudinal arranged holes; a row of cross arranged latten between holes are formed thereof; and a number of spacers, incorporated on the cross arranged latten; the strength of the flexible metal strip is much higher than that of the resin materials conventionally used and can endure higher tension without broken, and thus a longer operating duration can therefore be achieved; both ends on the flexible metal strip can be overlapped wholly fixed without interference because of thinner thickness thereof, and a close loop rolling element retainer chain is formed thereof.

The present invention is a continuation in part of U.S. patent application Ser. No. 12/243,966 which is assigned to and invented by the inventor and applicant of the present invention. Thus, the content of U.S. patent application Ser. No. 12/243,966 is incorporated into the present invention as a part of the present invention.

### FIELD OF THE INVENTION

The present invention relates to rolling element retainer chains in linear motion mechanism devices, and more particularly to a longitudinally extended and flexible rolling element retainer chain which retains a longitudinally extended row of rolling elements and keeps a predetermined distance between two adjacent rolling elements whereby the rolling element retainer chain and the rolling elements can circulate smoothly in the recirculation passage provided by the linear motion mechanism device such as linear guide, ball spline and the like.

### BACKGROUND OF THE INVENTION

The present mechanism of linear motion comprises a moving part and a guiding part which can extend longitudinally. Both of the moving part and the guiding part provide at least a coupled raceway to form a raceway passage. The moving part provides a return passage and a pair of turnaround passages for every coupled raceway. The turnaround passages connect the inlet and outlet of the return passage and the raceway, and a recirculation passage is therefore formed; a row of rolling elements roll on the raceway passage, through the turnaround passage to the return passage and from the return passage through the turnaround passage and back to the raceway passage. Therefore, the rolling elements can circulate in the recirculation passage by means of the rolling of the rolling elements unlimited; the moving part can therefore slide on the guiding part without limit.

To avoid the collision between two adjacent rolling elements, the design of a rolling element retainer chain is provided in the moving part. A plurality of spacers are interposed between rolling elements and connected by a connecting strip. Therefore, the rolling elements circulate with a predetermined distance between two adjacent rolling elements and the moving part can slide more smoothly. In conventional designs, as disclosed by JP 05-052217, the ball chain is made of resin through an injection molding process. But if the mechanism of linear motion has to be produced smaller or much compact, it will become more difficult to achieve through the injection molding process. Furthermore, because the low tension strength of resin materials, the ball chain will be unexpectedly broken during the recirculation and cause unsmooth sliding.

To overcome the problems mentioned above, as disclosed by U.S. Pat. No. 6,142,671, the retainers and the connecting strip are made by a flexible metal strip. Because the tension strength of metal materials is much higher than that of resin materials, the flexible metal strip can increase the tension strength of the rolling element retainer chain and make it not easy to be broken, furthermore, the thickness of the connecting strip will be decreased and the rolling element retainer can still keep high tension strength. If the thickness of the flexible metal strip is not less than 0.1 mm, it is easy to achieve small size design by stamping, punching and bending. Assume that the elastic modulus of metal materials is E, the thickness of the flexible metal strip is h, and the bending radius of the flexible metal strip is P, the maximal stress produced is σ_{R}.

$${σ}_{R} = \frac{E \cdot h}{2 \cdot ρ}$$

For example, for a steel strip, h=0.03 mm, E=210,000 N/mm², ρ=10 mm, so the maximal stress produced is σ_{R}=315 N/mm². Because the elastic modulus of metal materials is much higher than that of resin materials, under the same bending radius, it is necessary that the thickness of the flexible metal strip is much less than the thickness of the resin strip to avoid producing too high stress and to keep the bending resistance lower. But if the thickness of the flexible metal strip is less than 0.06 mm, it is difficult to achieve through the stamping, punching and bending processes, and it is also difficult to extra work on the flexible metal strip to make the claw part for spacing and retaining the rolling element. To make the manufacturing easier by increasing the thickness of the flexible metal strip, the bending resistance of the flexible metal strip will be also increased and it will cause the bending not sufficiently in the desired shape and cause the circulating obstructed when the two ends of the rolling element retainer chain passing through the turnaround passages. This will also cause the material fatigued and broken earlier as expected life time.

To overcome the problems mentioned above, as disclosed by U.S. Pat. No. 7,329,047, the rolling member connection belt comprises a corrugated-shaped metal belt, and it use the corrugated-shaped parts to increase bending portions and to share the span range of bending. In FIG. 34, FIG. 35 and FIG. 36, the bending span is 90°, the metal belt has N corrugations, the bending radius is ρ, and the depth of the corrugation is T. To simplify the calculation, assume the top of the corrugation to be a sharp point, therefore, the width of the corrugation is 2 W and the length of the corrugation is L. The geometric relationship is shown as below:

$$V = ρ \cdot ( 1 - cos ( \frac{{90}^{°}}{2 N} ) )$$

$$H = V + T$$

$$W = ρ \cdot sin ( \frac{{90}^{°}}{2 N} )$$

$$L = \sqrt{{W}^{2} + {H}^{2}}$$

$$r = \frac{L}{2 \cdot sin ( \frac{{90}^{°}}{4 N} )}$$

In FIG. 36, S represents the flexible metal strip without bending and S′ represents the flexible metal strip having bending radius ρ with 90° bending span. The bending angle on each corrugation between S and S′ is 90°/4N. To simplify the calculation, assume that the length of each corrugation of the flexible metal strip is L and bends with a uniform radius r. Therefore, if the thickness of the flexible metal strip is h and the maximal stress produced is σ_{R}.

$${σ}_{R} = \frac{E \cdot h}{2 \cdot r}$$

In general designs, the width of the guiding groove provided by the recirculation passage is 0.1 to 0.2 times of the diameter of the rolling element, the depth of the corrugation is less than the width of the guiding groove, and the turnaround radius is about 1.5 to 3.0 times of the diameter of the rolling element.

For example, for a rolling element with diameter φD=5 mm and a steel belt with elastic modulus E=210,000 N/mm² and turnaround radius ρ=10 mm therefore we will have the maximal stress produced σ_{R} on the corrugated-shaped steel belt under different conditions as following:

T=0.8 mm, h=0.0685 mm, N=20, 2 W=0.8 mm, σ_{R}=315N/mm²

T=1.0 mm, h=0.823 mm, N=20, 2 W=0.8 mm, σ_{R}=314 N/mm²;

T=0.8 mm, h=0.126 mm, N=60, 2 W=0.4 mm, σ_{R}=315 N/mm².

From above calculation we understand, under the same stress by larger number of corrugations N or deeper depth of the corrugation T the thickness of the flexible metal strip will be increased. In general design, as the example above, under the same stress, the thickness of the metal belt with corrugations is about 2 to 4 times of the thickness of the metal belt without corrugations, and this design will solve the problem caused by the metal belt without corrugations. But this design will make the both side faces of the corrugated-shape metal belt but not flat. Because the metal belt will run in the guiding groove provided by the recirculation passage of linear motion mechanism and the rolling element retainer chain and the rolling elements will be guided and running smoothly in the recirculation passage. Each corrugation is about perpendicular to the guiding groove, whereby the top point of each corrugation is unfavorable for the smooth running in the guiding groove. Also the guiding groove always comprise more than two portions and when the top point of each corrugation passes through the joint position where misalignment happens, it will cause an unstable vibration and unsmooth recirculation.

### SUMMARY OF THE INVENTION

The purpose of the present invention is to provide a rolling element retainer chain with flexible metal strips which can solve the problem of difficult manufacturing by stamping, punching or bending process and the problem of unsmooth recirculation caused by corrugation design mentioned above, the rolling element retainer chain with flexible metal strips can even increase the tensile strength of the connecting belt as the way of the corrugated-shape design can achieve.

According the purpose mentioned above, the present invention provides a rolling element retainer chain comprising at least a flexible metal strip and a number of spacers; the at least one flexible metal strip has longitudinally arranged holes on it, a row of cross arranged latten between holes are thereof formed, and the spacers are incorporated on the cross arranged latten; two connecting strips at upsides and downsides of the holes are thereof formed and all the cross arranged latten are incorporated on the connecting strips; a row of longitudinally arranged rolling elements are disposed in the holes and a predetermined distance is kept between two adjacent rolling elements by the spacers; the connecting strips run in the guiding groove provided by the recirculation passage to guide the rolling element retainer chain running smoothly in the recirculation passage. The rolling element retainer chain runs about straightly in the raceway passage and the return passage and curvedly with the arc of the turnaround passage in the turnaround passage, the rolling element retainer chain repeats bent and straightened thereby during recirculation. To avoid the plastic deformation caused by repeated stress, the thickness of the flexible metal strip h is restricted as h<hₒ and hₒ=2·R_{p0.2}·ρ/E, where E is the elastic modulus of the metal material, R_{p0.2} is the yielding strength of 0.2% plastic deformation of the metal material and ρ is the minimum turnaround radius of the guiding groove provided by the turnaround passage. Therefore, the rolling element retainer chain will achieve repeating bent without plastic deformation when passing the turnaround passage.

To achieve expected life or repeat times without fatigued, according to the property of each metal, a suitable coefficient f is chosen to determine the thickness of the flexible metal strip h≦f·hₘ and hₘ·2·Rₘ·ρ/E, where Rₘ is the tensile strength of the metal material. For example, if the metal is steel and the expected repeat times of bending are more than 1 million times, the coefficient f=0.6˜0.7. the guiding groove provided by the recirculation passage is closed and usually comprises more than two portions, and the joint position will form discontinuous surface caused by misalignment or positioning error. Because the both side faces of the metal connecting strip have no corrugations and keep flat, when passing through the joint position in the guiding groove, an unsmooth recirculation will not happen.

The face of the spacer adjacent to the rolling element forms an envelop shape, the rolling element is thereby retained between two envelop shaped face of spacers in the rolling element retainer chain without freely escaping. The flexible metal strip having longitudinally arranged holes but without claw portion can be made by stamping, punching or etching process in much thinner thickness.

The materials of the spacer may be resin materials, including the resin materials mixed by oil-containing, glass-fiber, carbon-fiber and the like.

Said resin spacers can be incorporated on the flexible metal strip by injection molding directly. By another incorporating method, the spacer is divided into left and right half-spacers by the flexible metal strip, and there are coupled pins and holes and a recess for receiving the cross arranged latten on the left and right half-spacers, hence a complete spacer is formed by combining the left and right half-spacers through the coupling of the coupled pins and holes on the left and right sides of the cross arranged latten of the flexible metal strip. By another incorporating method, the spacer is divided into front and rear half-spacers by the plane perpendicular to the flexible metal strip, and there are coupled pins and holes and a recess for receiving the cross arranged latten on the front and rear half-spacers, hence a complete spacer is formed by combining the front and rear half-spacers through the coupling of the coupled pins and holes on the front and rear sides of the cross arranged latten of the flexible metal strip.

The pins of the front and rear half-spacers can protrude out the front and rear half-spacers, and the end faces of the pins form a envelop shape face adjacent to the rolling elements. The rolling elements are enveloped and separated by the end faces of the pins thereof; lubricant can be stored in the recess around the pins and will not be drained when the rolling elements rolling in the recirculation passage and a direct lubrication on the rolling elements can be kept for a long operating time.

To increase the bending ability of the flexible metal strip, the thickness of the flexible metal strip h shall be decreased; it will cause the tension strength of the rolling element retainer chain with flexible metal strips become low. To solve this problem, the rolling element retainer chain has at least two flexible metal strips overlapped and the spacers are incorporated on the overlapped cross arranged latten of the flexible metal strips to increase the tension strength of the rolling element retainer chain. The thickness of each flexible metal strip is restricted as h₁, h₂, . . . <hₒ and hₒ=2·R_{p0.2}·ρ/E. Because each flexible metal strip can be bent independently, the rolling element retainer chain comprising a plurality of flexible metal strips can keep the same bending ability as the rolling element retainer chain comprising one single flexible metal strip and the tension strength of the rolling element retainer chain comprising a plurality of flexible metal strips can increase multiply in accordance with the number of the overlapped flexible metal strips increased.

By the incorporating methods of left and right half-spacers or front and rear half-spacers, the recess for receiving the flexible metal strips on the left and right half-spacers or the front and rear half-spacers can be a little larger than the cross arranged fatten of the flexible metal strips, to provide space for the free opposite movement between the flexible metal strips when being bent. Whereby the bending resistance and the produced maximal stress of the rolling element retainer chain with a plurality of overlapped flexible metal strips remains the same as that with one flexible metal strips.

To enhance the strength of the spacers of the rolling element retainer chain with at least one flexible metal strip, the cross arranged latten between the longitudinal arranged holes of at least one flexible metal strip are separated as upside and downside portions; the upside and downside half cross arranged latten are firmly connected through the spacers and a rolling element retainer chain is formed thereof.

To decrease the friction caused by the flexible metal strip having higher friction coefficient running in the recirculation guiding groove, the at least one flexible metal strips cane be covered by resin materials having lower friction coefficient by injection molding process together with spacers.

The rolling elements can be balls, rollers or the like.

Because the thickness of the flexible metal strip is much less than the thickness of the rolling element retainer chain made of resin materials, more space exists for overlapping the flexible metal strips; whereby the two ends of the flexible metal strip can be overlapped wholly. There is at least one half-spacer on one end of the flexible metal strip and a corresponding half-spacer on the other end of the flexible metal strip for coupling. At least one complete spacer is formed by combining the at least one half-spacer and its coupled half-spacer through the coupled pins and holes on the half-spacer; the overlap portion on both ends of the flexible metal strips is thereof firmly combined and a closed loop of the rolling element retainer chain with at least one flexible metal strip is achieved. Such design solves the problem of unsmooth recirculation caused by an opened loop of rolling element retainer chain.

In another embodiment of the present invention, a half rolling element retainer chain with at least one flexible metal strip comprises at least one flexible metal strip and half-spacers disposed on one side of the at least one flexible metal strip, coupled pins and holes on the half-spacers. At least one flexible metal strip and half-spacers can be incorporated together by injection molding process. A complete rolling element retainer chain is formed by combining two half flexible metal strip rolling element retainer chains with at least one flexible metal strip through the coupling of the coupled pins and holes on the half-spacers. The embodiment of half flexible metal strip rolling element retainer chain spilt the spacers having envelop shape into two halves, such half spacers simplify and solve the difficulty of a complete rolling element retainer chain having spacers with envelop shape while withdrawing directly from the molding die by injection molding process.

### BRIEF DESCRIPTION OF THE DRAWINGS

FIG. 1 is the side view of the flexible metal strip rolling element retainer chain disclosed by the present invention.

FIG. 2 is a cross sectional view along line I-I of FIG. 1.

FIG. 3 is a cross sectional view along line II-II of FIG. 1.

FIG. 4 is a part view of the flexible metal strip of the rolling element retainer chain disclosed in the present invention.

FIG. 5 is an illustrated section view of the flexible metal strip rolling element retainer chain disclosed in the present invention circulating in the moving part.

FIG. 6 is a side view showing the design of the cross arranged latten of the rolling element retainer chain disclosed in the present invention.

FIG. 7 is the perspective view of the second embodiment of the spacers of the rolling element retainer chain disclosed in the present invention.

FIG. 8 is a view of the focus A of FIG. 7.

FIG. 9 is a side view of the third embodiment of the spacers of the rolling element retainer chain disclosed in the present invention.

FIG. 10 is a view focusing on part B of FIG. 9.

FIG. 11 is a perspective view of the front half-spacer of the third embodiment of the spacers disclosed in the present invention.

FIG. 12 is a top view of the front half-spacer of the third embodiment of the spacers disclosed in the present invention.

FIG. 13 is a cross sectional view along line III-III of FIG. 12.

FIG. 14 is a top view of the rolling element retainer chain with a plurality of flexible metal strips disclosed in the present invention.

FIG. 15 is a view focusing one part C of FIG. 14.

FIG. 16 is the diagram showing plurality of flexible metal strips according to the present invention.

FIG. 17 is a side view of the left half-spacers having wider recesses incorporated on a plurality of flexible metal strips according to the present invention.

FIG. 18 is a section view of the front and rear half-spacers having wider recesses incorporated on a plurality of flexible metal strips of the present invention.

FIG. 19 is atop view showing another embodiment of the rolling element retainer chain with at least one flexible metal strip disclosed in the present invention.

FIG. 20 is a side view of the rolling element retainer chain with resin material covering on it disclosed in the present invention.

FIG. 21 is a cross sectional view along line VI-VI of FIG. 20.

FIG. 22 is a cross sectional view along line V-V of FIG. 20.

FIG. 23 is a perspective view of the rolling element retainer chain with rollers according to the present invention.

FIG. 24 is a top view of the rolling element retainer chain with rollers in present invention.

FIG. 25 is a cross sectional view along line VII-VII of FIG. 24.

FIG. 26 is the side view of the embodiment of the rolling element retainer chain with a plurality of flexible metal strips with ends connecting embodiment disclosed by the present invention.

FIG. 27 is a top view of the embodiment of the rolling element retainer chain with a plurality of flexible metal strips with ends connecting embodiment disclosed in the present invention.

FIG. 28 is a top view of the connecting of both ends of the rolling element retainer chain with a plurality of flexible metal strips disclosed in the present invention.

FIG. 29 is the illustrated perspective view of the connection on both ends of the rolling element retainer chain with a plurality of flexible metal strips disclosed in the present invention.

FIG. 30 is the side view of the embodiment with half flexible metal strip rolling element retainer chain disclosed in he present invention.

FIG. 31 is a cross sectional view along line VIII-VIII of FIG. 30 and the cross sectional view of the other coupled half flexible metal strip rolling element retainer chain.

FIG. 32 is a perspective view of the combining of two half flexible metal strips rolling element retainer chains disclosed in the present invention.

FIG. 33 is a view focusing in part D of FIG. 32.

FIG. 34 is a section view of the corrugated-shaped metal belt in the turnaround passage.

FIG. 35 shows the geometric relationship of the corrugation of bent corrugated-shaped metal belt.

FIG. 36 is a geometric relationship diagram of the straight and bent corrugated-shaped metal belt.

### DETAILED DESCRIPTION OF THE PREFERRED EMBODIMENTS

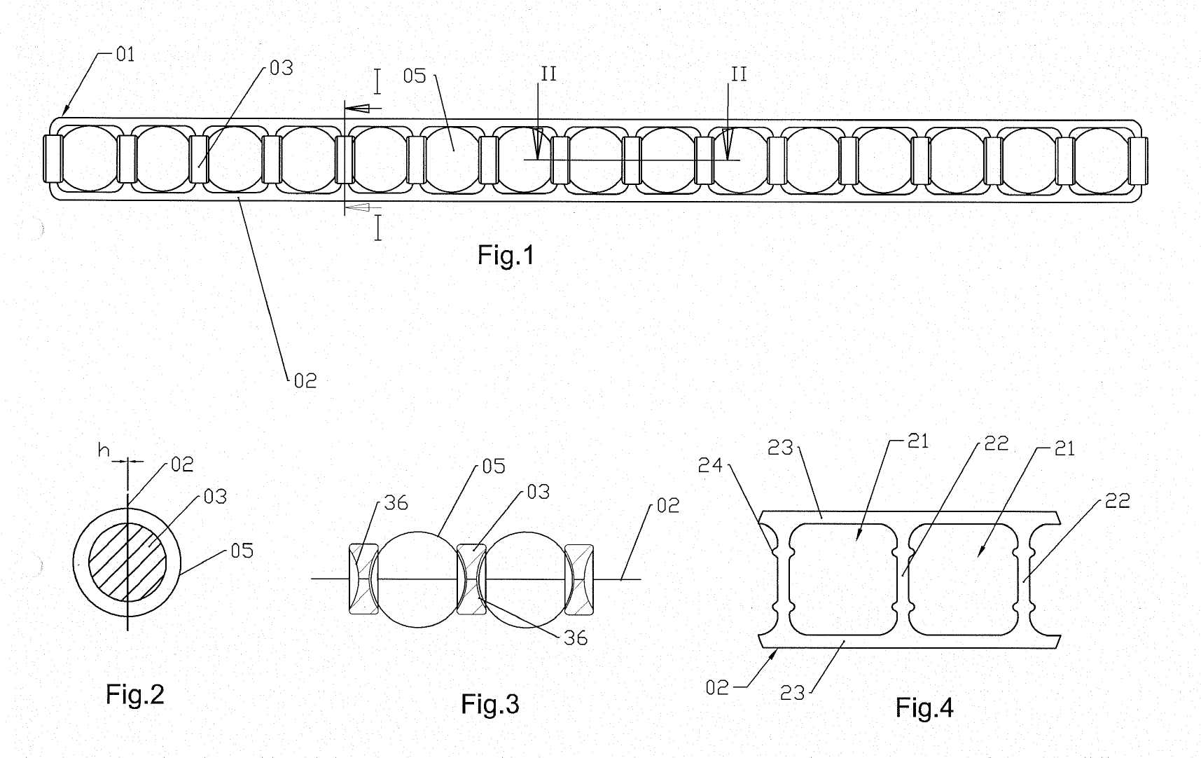

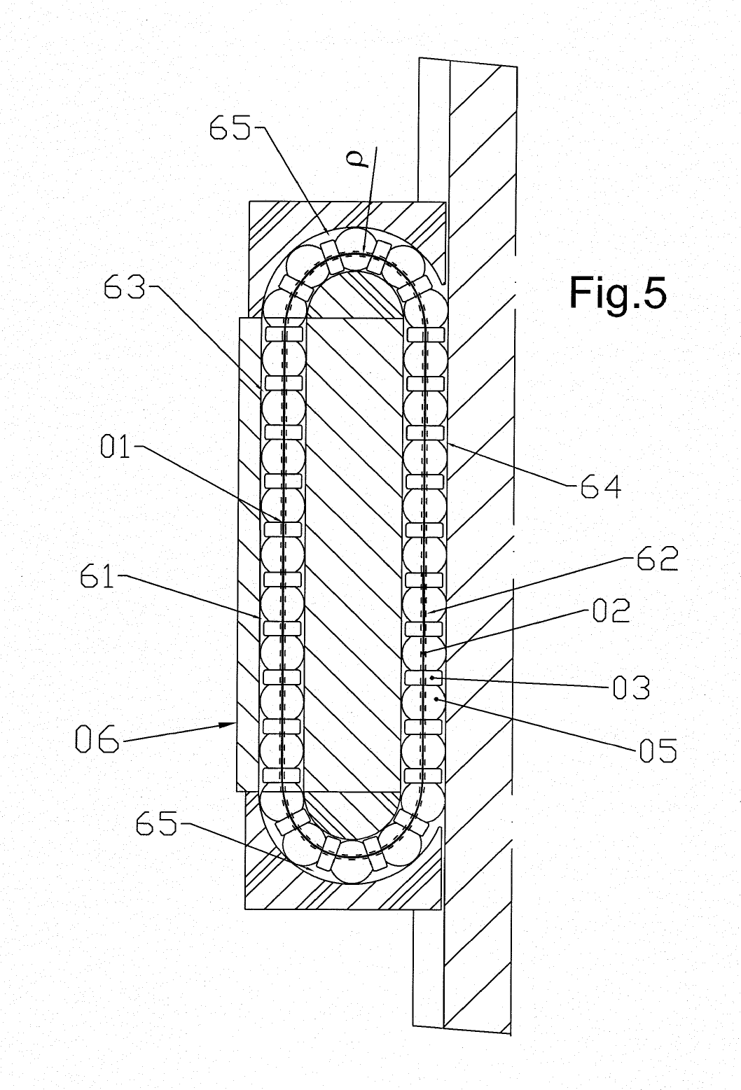

As shown in FIG. 1 and FIG. 2, a rolling element retainer chain 01 comprises a flexible metal strip 02 and a plurality of spacers 03, wherein the flexible metal strip has a row of longitudinally arranged holes 21 on it. As shown in FIG. 4, a row of cross arranged latten 22 is formed between the holes 21. Two connecting strips 23 are formed at both upside and downside of the holes 21 and all of the cross arranged latten 22 are connected to the connecting strips 23; the spacers 03 are incorporated on the cross arranged latten 22. A row of rolling elements 05 are located in the holes 21 in a predetermined distance and separated by the spacers 03. As shown in FIG. 3, the face of the spacer 03 opposite to the rolling element 05 forms an envelop shape 36, and the rolling elements 05 are retained by two adjacent envelop shaped faces 36 of the spacers 03 in the rolling element retainer chain 01 without freely escaping. As shown in FIG. 5, the rolling element retainer chain 01 and the row of rolling elements 05 circulate in the recirculation passage 61 provided by the moving part 06. A groove 62 extended along the direction of recirculation is provided by the recirculation passage 61 and the connecting strip 23 of the rolling element retainer chain 01 is guided in the groove 62. the rolling element retainer chain 01 runs about straightly in the raceway passage 64 and the return passage 63 and curvedly with the turnaround passage 65 having the minimum arc ρ, therefore, the rolling element retainer chain 01 bent and straightened repeatedly during recirculation. To avoid the plastic deformation caused by repeated stress, the thickness of the flexible metal strip 02 h, as shown in FIG. 2, is restricted as h<hₒ and hₒ=2·R_{0.2p}·ρ/E, where E is the elastic modulus of the metal material, R_{0.2p} is the yielding strength of 0.2% plastic deformation of the metal material and ρ is the minimum radius of the turnaround passage. Therefore, the rolling element retainer chain 01 will achieve the object of bending repeatedly without plastic deformation when passing the turnaround passage 65.

To achieve an expected life or recirculation times without broken caused by material fatigue and according to the property of material, a suitable coefficient f is introduced for the selection of the thickness h of the flexible metal strip 02, h≦f·hₘ and hₘ=2·Rₘ·ρ/E, where Rₘ is the tensile strength of the metal material. For example, if the material of the flexible metal strip 02 is steel and the expected repetition times of straight-bending are more than 1 million times, then the coefficient f=0.6˜0.7. Both side faces of the connecting strips 23 of the flexible metal strip 02 are flat without corrugations.

As shown in FIG. 6, the cross arranged latten 22 can be incorporated with the spacers 03, and the cross arranged latten 22 provide protrusions 24, indentations 25 or small holes 26 on the cross arranged latten 22 to prevent the displacement of the spacers 03 along the cross arranged latten 22 longitudinally. It is preferred that the protrusions 24, the indentations 25 or the small holes 26 locate near the both end sides of the cross arranged latten 22 to decrease the width in the middle portion of the cross arranged latten 22 and the distance between two adjacent the rolling elements 05 can thereof be minimized.

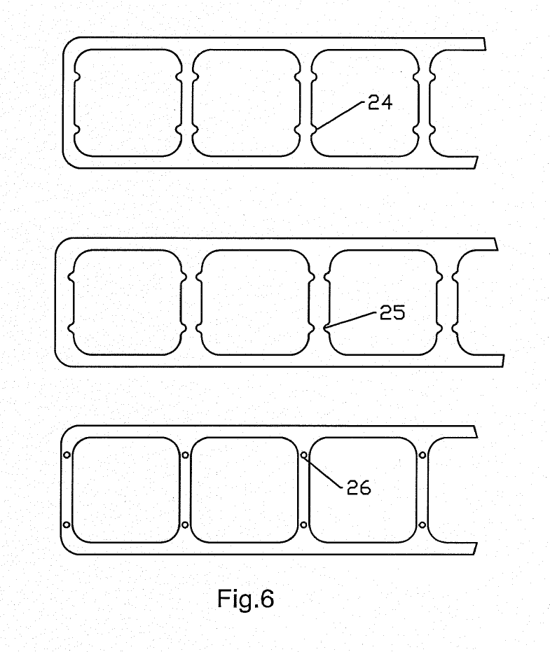

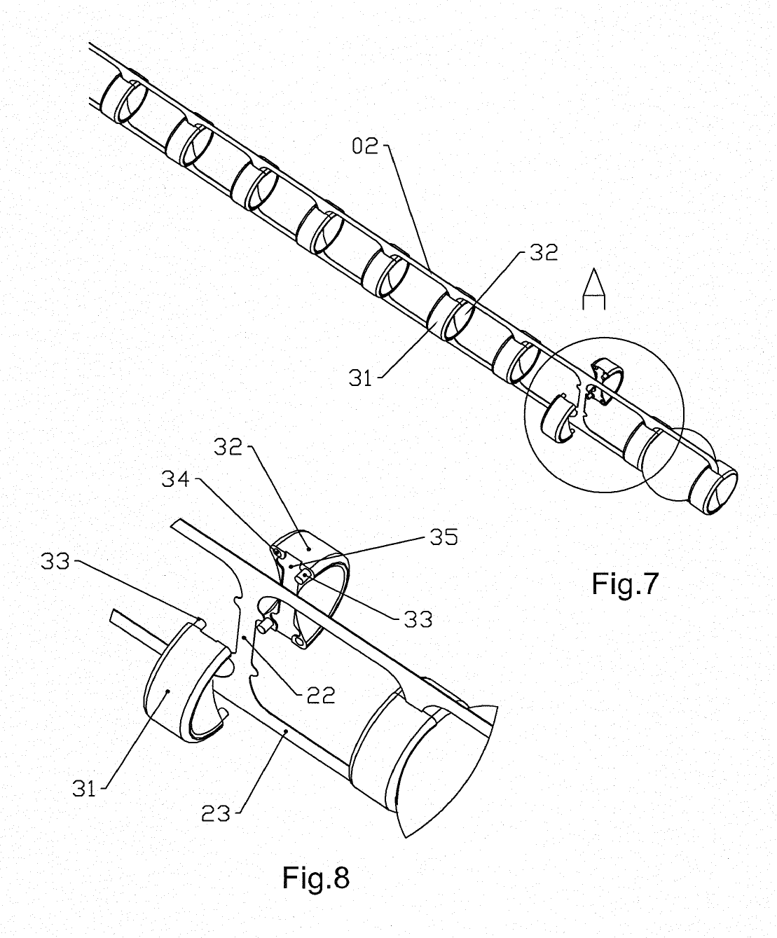

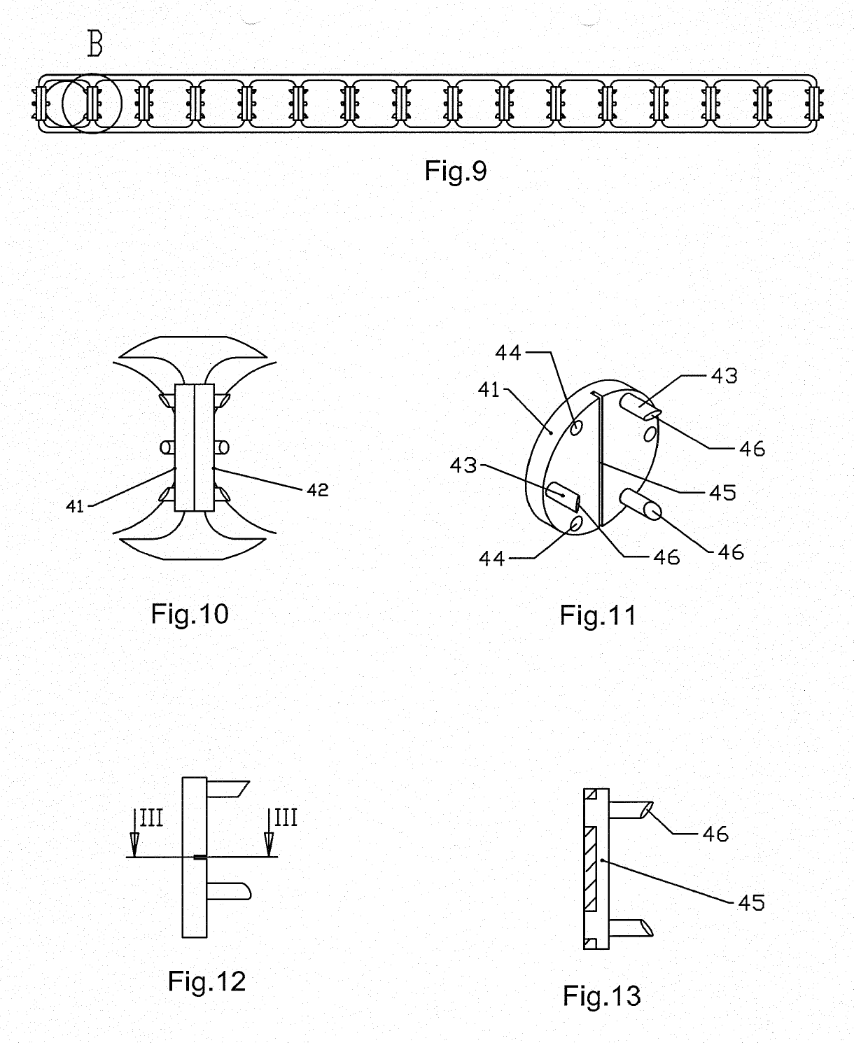

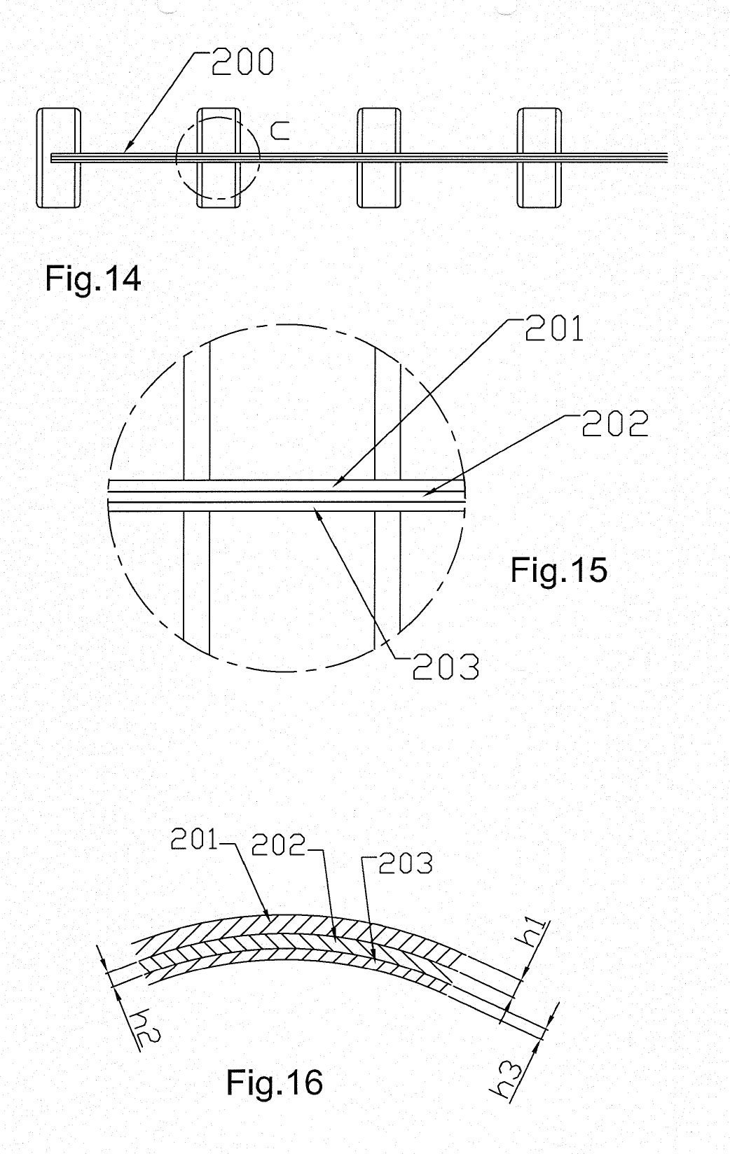

The flexible metal strip 02 can be made by stamping, punching, etching or laser cutting. As shown in FIG. 1, the spacers can be directly incorporated on the flexible metal strip 02 by injection molding process. As shown in FIG. 7 and FIG. 8, the second embodiment of the incorporation method is to divide the spacer 03 into left and right half-spacers 31 and 32 by the flexible metal strip 02, and there are coupled pins 33, holes 34 and a recess 35 for receiving the cross arranged latten 22 on the left and right half-spacers 31 and 32. Hence a complete spacer 03 is formed by combining the left and right half-spacers 31 and 32 on the cross arranged latten 22 through the coupling of the coupled pins 33 and holes 34. As shown in FIG. 9 and FIG. 10, the third embodiment of incorporation method is to divide the spacers 03 into front and rear half-spacers 41 and 42 by the perpendicular plane to the flexible metal strip 02. As shown in FIG. 11, FIG. 12 and FIG. 13, there are coupled pins 43, holes 44 and a recess 45 for receiving the flexible metal strip 02 on the front and rear half-spacers 41 and 42. Hence a complete spacer 03 is formed by combining the front and rear half-spacers 41 and 42 on the cross arranged latten 22 through the coupling of the coupled pins 43 and holes 44. As shown in FIG. 10, the pins 43 can protrude out of the front and rear half-spacers 41 and 42, and the end faces 46 of the pins 43 form an envelop surface for receiving the rolling elements 05. the rolling elements 05 are thereof retained and separated by the end faces 46 of two adjacent spacers, and lubricant can be stored in the recess between the pins 43 and keep direct lubrication on the rolling elements 05.

As shown in FIG. 15, the at least one flexible metal strip 200 is formed by a plurality of flexible metal strips 201, 202, 203, . . . , overlapped and the resin spacers 03 are incorporated on the flexible metal strip 200, hence the tension strength of the rolling element retainer chain 01 increases. The thickness of each of the plurality of flexible metal strips 200, h1, h2, h3, . . . is restricted as h₁, h₂, h₃, . . . <hₒ where ho is defined as above. As shown in FIG. 16, because each flexible metal strip 201, 202, 203, . . . can be bent independently, the rolling element retainer chain comprising the plurality of flexible metal strips 200 can keep the same bending ability as the rolling element retainer chain comprising single flexible metal strip but the tension strength of the rolling element retainer chain comprising the plurality of flexible metal strips 200 can be increased multiply in accordance with the number of the overlapped flexible metal strips layer.

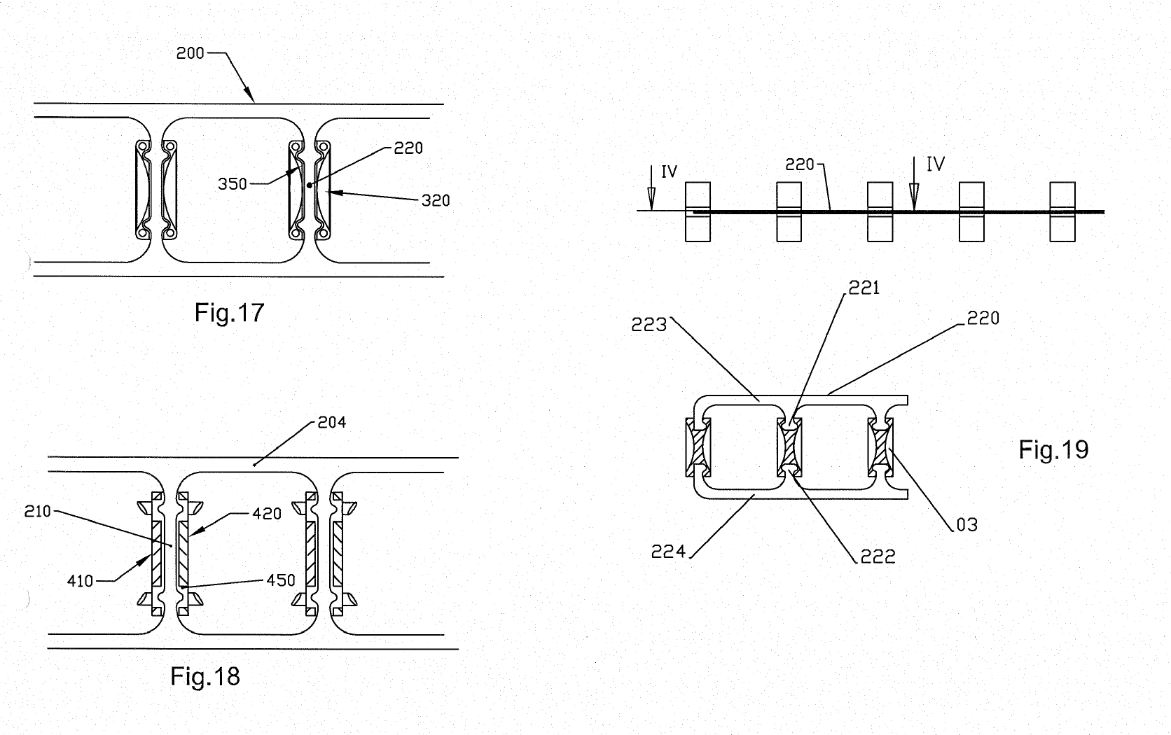

By using the method of combining the left and right or the front and rear half-spacers 31, 32 and 41, 42, as shown in FIG. 8 and FIG. 10, the recesses 350 and 450, as shown in FIG. 17 and FIG. 18, for receiving the plurality of flexible metal strips 200 on the left and right or front and rear half-spacers 320, 410 and 420 can be a little larger than the cross arranged latten 220 to provide space for the free opposite movement between the flexible metal strips 201, 202, 203, . . . when being bent.

To enhance the strength of the spacers 03, the cross arranged latten 02 between the longitudinally arranged holes 21 of the at least one flexible metal strip 02 are divided into upside and downside half crossed arranged latten 221 and 222 and connected on the connecting strip 23 respectively, as shown in FIG. 19, which are incorporated with upside and downside portions of the spacers 03 to form a complete rolling element retainer chain.

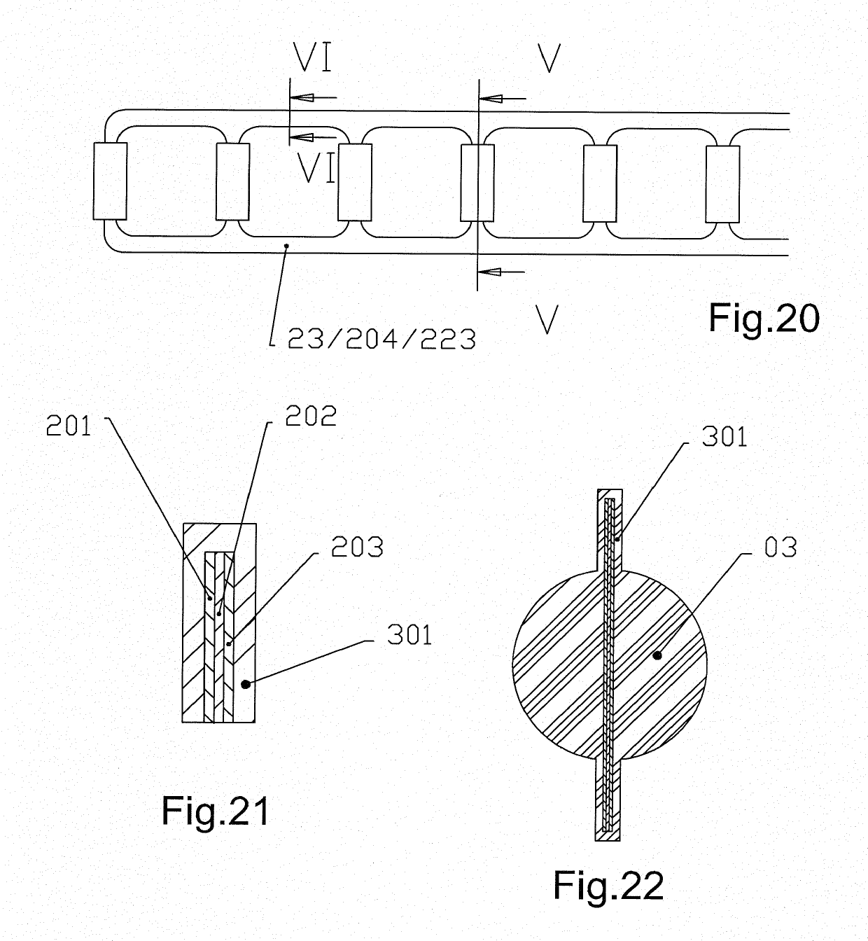

As shown in FIG. 20, FIG. 21 and FIG. 22, to decrease the friction caused by the sliding of the metal connecting strip 23, 204 and 223 on the recirculation guiding groove 62, the metal connecting strip 23, 204 and 223 can be covered by a resin layer 301 having lower friction coefficient by injection molding together with the spacers 03.

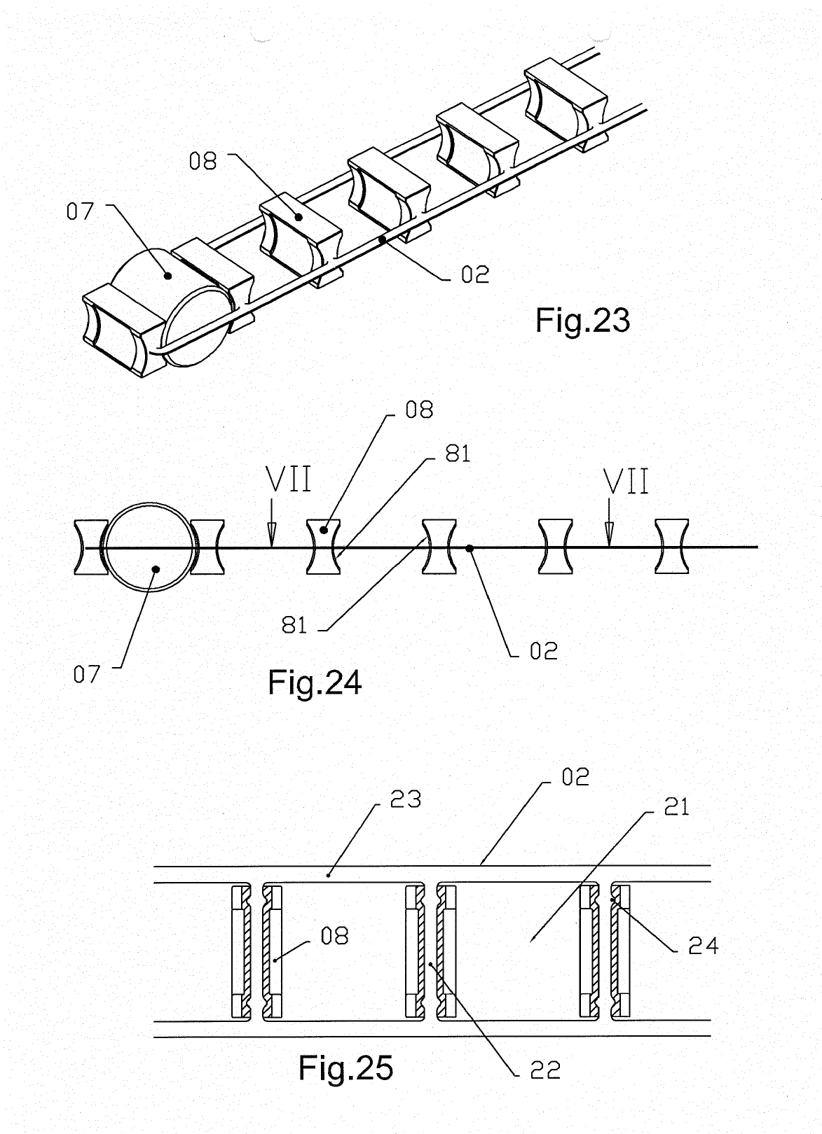

As shown in FIG. 23, FIG. 24 and FIG. 25 the rolling elements 05 can be rollers 07, the roller spacers 08, incorporated on the cross arranged latten 22 and having envelop shape faces 81 opposite to the adjacent rollers 07, can separate the rollers 07 to avoid the collision with each other and retained the rollers 07 in the rolling element retainer chain 01 without freely escaping.

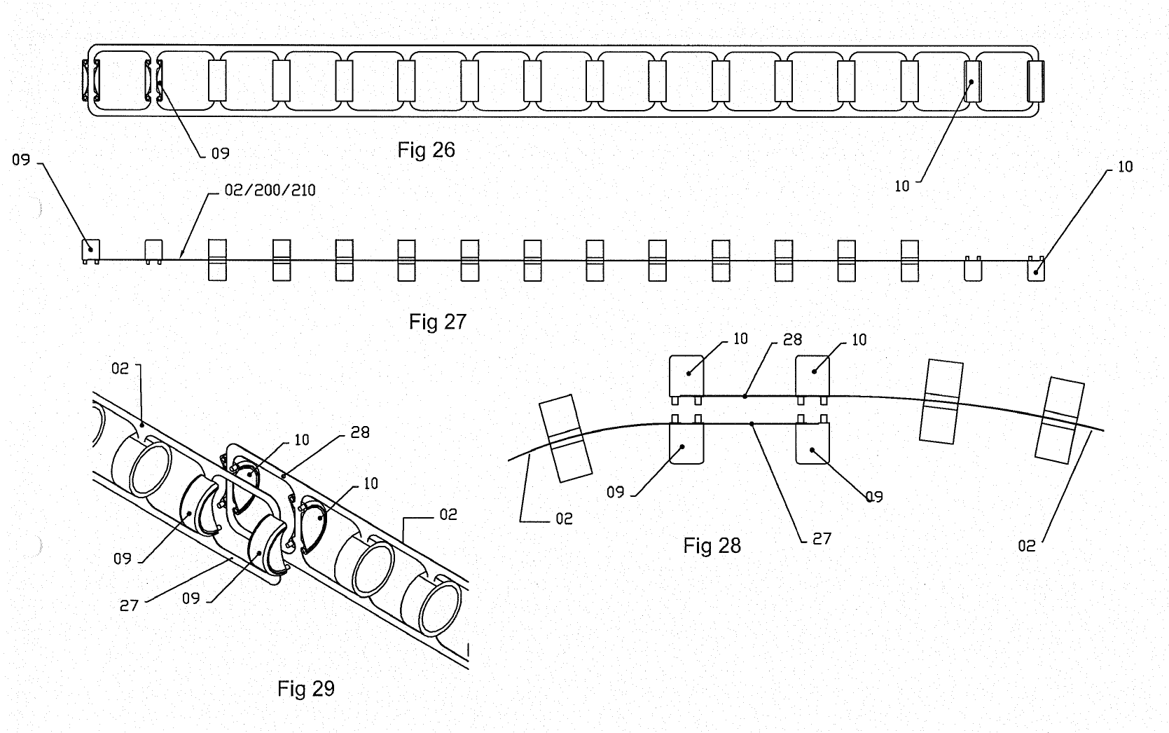

As shown in FIG. 26 and FIG. 27, two half-spacers 09 are provided on one end of the flexible metal strip 02 and two coupled half-spacers 10 provided on the other end of the flexible metal strip 02, and there are coupled pins and holes on the half-spacers 09 and 10. As shown in FIG. 28 and FIG. 29, two complete spacers are formed by combining the half-spacers 09 and 10; whereby two end portions 27 and 28 of flexible metal strip 02, having one hole 21, are overlapped wholly and fixed and a close loop rolling element retainer chain 01 is formed.

The length of the overlapped portion 27 and 28 can be increased or decreased by increasing or decrease the number of combined the half-spacers 09 and 10.

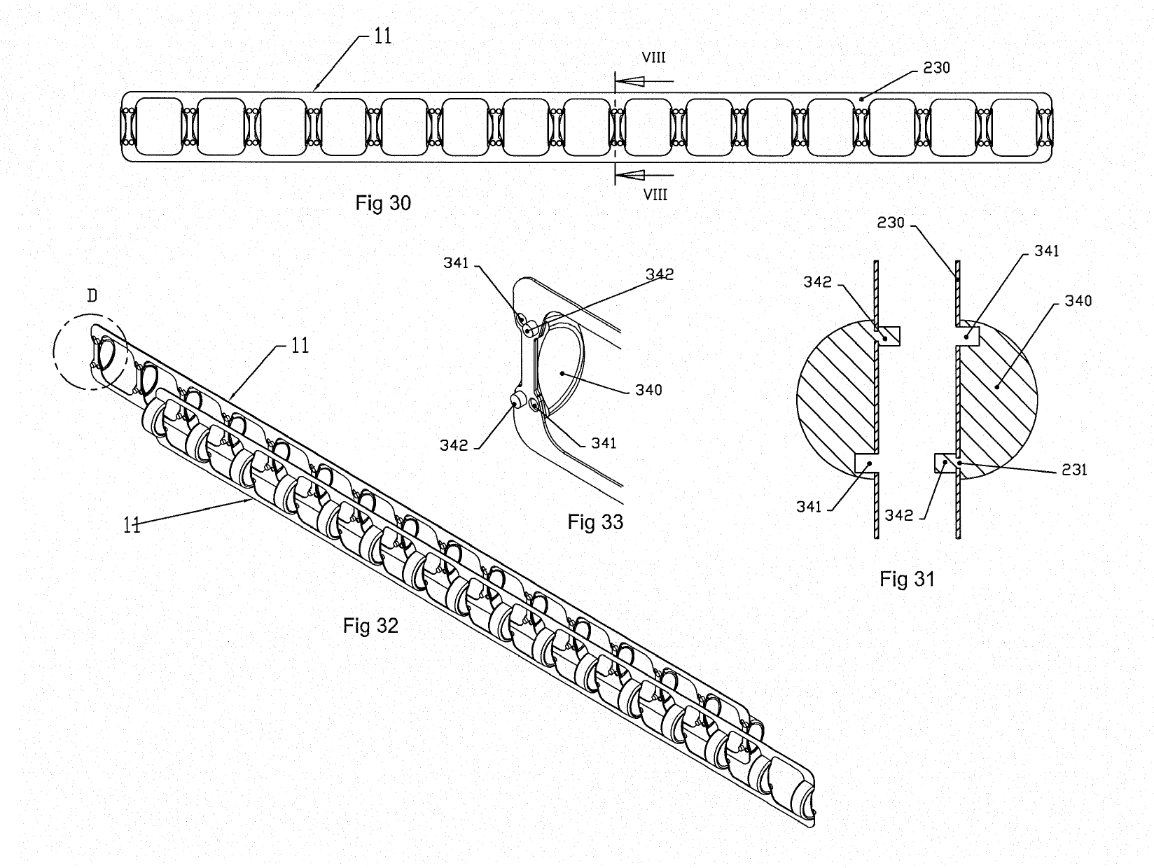

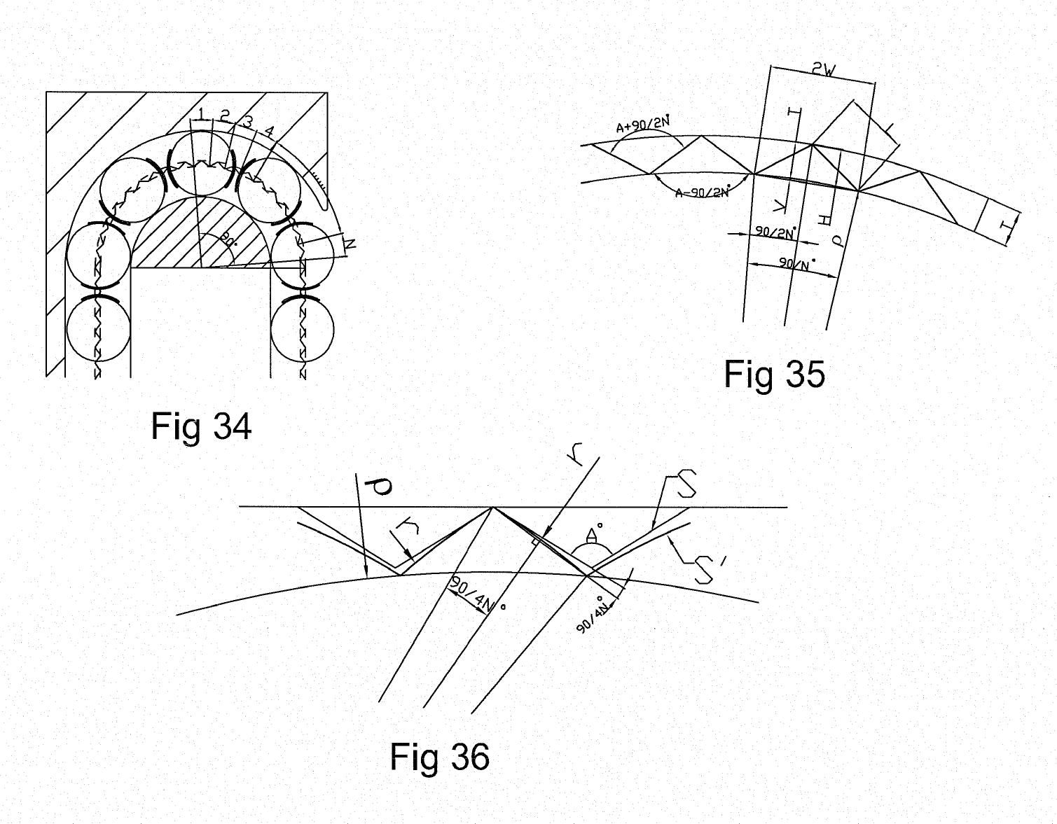

FIG. 30, FIG. 31, FIG. 32 and FIG. 33 show another embodiment of the rolling element retainer chain 01; a half flexible metal strip rolling element retainer chain 11 comprises at least one flexible metal strip 230 and half-spacers 340, and there are coupled pins 342 and holes 341 on the half-spacers 340. Because the diameter of the pins 342 is larger than the diameter of holes 231 on the at least one flexible metal strip 11, the at least one flexible metal strip 230 and the half-spacers 340 can be incorporated together by injection molding process. A complete rolling element retainer chain 01 is formed by combining two the half flexible metal strip rolling element retainer chain 11 through the coupling of the pins 342 and holes 341, and two the half flexible metal strips 230 can be incorporated together closely.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A rolling element retainer chain comprising:
at least one flexible metal strip having a plurality of longitudinally arranged holes, a row of cross arranged latten between holes are formed thereof; and a plurality of cross arranged spacers combined to the cross arranged latten; a plurality of rolling elements are held in the holes and retained with a predetermined distance to each other.

2. The rolling element retainer chain according to claim 1, wherein a thickness h of said flexible metal strip is restricted by
$$h < \frac{2 \cdot ρ \cdot {R}_{p 0.2}}{E} ,$$
where E is the elastic modulus of metal materials, ρ is the minimum bending radius of said flexible metal strip curved in said turnaround passage, R_{p0.2} is the yielding strength under 0.2% plastic deformation of said flexible metal strip's materials.

3. The rolling element retainer chain according to claim 1, wherein said cross arranged latten of said flexible metal strip have at least one of protrusions, indentations and holes to prevent the displacement of said spacers moving.

4. The rolling element retainer chain according to claim 1, wherein said spacers are made of resin materials.

5. The rolling element retainer chain according to claim 4, wherein said spacers are incorporated on cross arranged latten of said flexible metal strip by injection molding directly.

6. The rolling element retainer chain according to claim 1, wherein said spacers are formed by combining the left and the right half-spacers through coupling of the coupled pins and holes on said half-spacers, and said left and right half-spacers having recesses for receiving said cross arranged latten while incorporating on said cross arranged latten of said flexible metal strip.

7. The rolling element retainer chain according to claim 2, wherein said spacers are formed by combining the front and the rear half-spacers through the coupling of the coupled pins and holes on said half-spacers and said front and rear half-spacers having recesses for receiving said cross arranged latten while incorporating on said cross arranged latten of flexible metal strip.

8. The rolling element retainer chain according to claim 6, wherein pins on said front and rear half-spacers can protrude out of said two said half-spacers and a envelop shape faces adjacent to said rolling elements are formed by the end faces of said pins.

9. The rolling element retainer chain according to claim 1, wherein said holes of said flexible metal strip are made by at least one of stamping, punching, etching or laser cutting.

10. The rolling element retainer chain according to claim 1, wherein said at least one flexible metal strip is formed by overlapping a plurality of said flexible metal strips and the thickness h₁, h₂, h₃, . . . of each said flexible metal strip is restricted as
$${h}_{1} , {h}_{2} , {h}_{3} , … < \frac{2 \cdot ρ \cdot {R}_{p 0.2}}{E} ,$$
where E is the elastic modulus of flexible metal strip material, ρ is the minimum bending radius of said flexible metal strip curved in said turnaround passage, R_{p0.2} is a yielding strength under 0.2% plastic deformation of said flexible metal strip materials.

11. The rolling element retainer chain according toy claim 5, wherein said recesses for receiving said cross arranged latten of flexible metal strip are largish than the cross arranged latten of flexible metal strip.

12. The rolling element retainer chain of claim 1 wherein said cross arranged latten of flexible metal strip are divided into upside and downside half cross arranged latten and connected by said spacers.

13. The rolling element retainer chain according to claim 4, wherein said metal connecting strip and said spacers are covered by a resin layer which is injection molded together with said spacers.

14. The rolling element retainer chain according to claim 1, wherein said rolling elements are selected from balls and rollers.

15. The rolling element retainer chain according to claim 1, wherein said rolling element retainer chain provides at least one half-spacers on both ends, by combining said half-spacers into complete spacers the both ends of said flexible metal strip are overlapped wholly and fixed together and a close-loop rolling element retainer chain is formed thereof.

16. The rolling element retainer chain according to claim 1, wherein said rolling element retainer chain is made of two half rolling element retainer chains, which are formed by combining at least one flexible metal strip and half-spacers through the coupling of the coupled pins and holes on said half-spacers, at least one flexible metal strip and half-spacers are incorporated together by injection molding process.
